(19) United States
(12) Patent Application Publication
(10) Pub. No.: US 2025/0283662 A1
(43) Pub. Date: Sep. 11, 2025

(54) SINTERING FURNACE

(71) Applicants: TINCI MATERIALS (TAIZHOU) CO., LTD., Taizhou (CN); GUANGZHOU TINCI MATERIALS TECHNOLOGY CO., LTD., Guangzhou (CN)

(72) Inventors: Hui HUANG, Taizhou (CN); Haishen SONG, Taizhou (CN); Chao LIU, Taizhou (CN); Litao SHI, Taizhou (CN)

(21) Appl. No.: 19/216,766

(22) Filed: May 23, 2025

Related U.S. Application Data
(63) Continuation of application No. PCT/CN2024/093116, filed on May 14, 2024.

(30) Foreign Application Priority Data
Apr. 9, 2024 (CN) 202410423457.7
Apr. 9, 2024 (CN) 202420728944.X

(51) Int. Cl. F27B 7/02; F27B 7/16; F27B 7/22; F27B 7/24; F27B 7/26; F27B 7/32

(52) U.S. Cl. CPC F27B 7/02; F27B 7/24; F27B 7/26; F27B 7/3205; F27B 2007/025; F27B 7/16; F27B 2007/2246; F27B 2007/2273; F27B 2007/3223; F27M 2003/04

(57) ABSTRACT

Provided is a sintering furnace. The sintering furnace includes: a furnace body and a furnace head cover having a feed inlet, the furnace head cover covering a furnace head of the furnace body, the furnace head cover being axially limited relative to the furnace head, the furnace body being rotatable around a central axis relative to the furnace head cover, and the feed inlet being in communication with an interior of the furnace body; a sliding support structure including a first sliding structure configured to support the furnace head cover, the furnace head cover being fixedly connected to the first sliding structure, and the first sliding structure being slidably arranged in a length direction of the furnace body; and a feeding device in communication with the feed inlet through a flexible connection pipe.

### CROSS-REFERENCE TO RELATED APPLICATION

This application is a continuation of International Application No. PCT/CN2024/093116, filed on May 14, 2024, which claims priorities to Chinese patent applications Nos. 202410423457.7 and 202420728944.X, filed by TINCI MATERIALS (TAIZHOU) CO., LTD. and GUANGZHOU TINCI MATERIALS TECHNOLOGY CO., LTD. on Apr. 9, 2024, the entire contents of which are incorporated herein by reference.

### FIELD

The present disclosure relates to the field of sintering equipment technologies, and more specifically, to a sintering furnace.

### BACKGROUND

A sintering process of lithium iron phosphate mostly uses a roller hearth kiln or a pusher kiln as a primary carrier. An application of a large-scale rotary furnace in a high-temperature solid-phase reaction of lithium iron phosphate represents a key industry breakthrough. The rotary furnace offers advantages such as a high degree of automation, large production capacity, and excellent product stability. However, due to a “large size” of the rotary furnace, the rotary furnace has a more complex structure compared with the roller hearth kiln and the pusher kiln, which poses challenges in maintaining operational stability.

### SUMMARY

The present disclosure aims to solve at least one of the technical problems in the related art. To this end, an objective of the present disclosure is to provide a sintering furnace. The sintering furnace is capable of adapting to an expansion or contraction deformation of a furnace body, improving support stability and feeding stability, and achieving relatively high operational stability.

According to an embodiment of the present disclosure, a sintering furnace is provided. The sintering furnace includes a furnace body, a furnace head cover, a sliding support structure and a feeding device. The furnace head cover has a feed inlet. The furnace head cover is sleeved on a furnace head of the furnace body. The furnace head cover is axially limited relative to the furnace head. The furnace body is rotatable around a central axis relative to the furnace head cover. The feed inlet is in communication with an interior of the furnace body. The sliding support structure includes a first sliding structure configured to support the furnace head cover. The furnace head cover is fixedly connected to the first sliding structure. The first sliding structure is slidably arranged in a length direction of the furnace body. The feeding device is in communication with the feed inlet through a flexible connection pipe.

With the sintering furnace according to the embodiment of the present disclosure, an end of the furnace body is sealed through a structural engagement between the furnace head cover and the furnace head or through a further sealing structure provided between the furnace head cover and the furnace head. In addition, through the cooperation of the sliding support structure, the furnace head cover and the flexible connection pipe, the sintering furnace can adapt to an expansion or contraction deformation of the furnace body, in such a manner that the furnace head cover and the furnace body are continuously supported in a stable manner during the expansion or contraction deformation. In this way, a satisfactory axial engagement and a satisfactory circumferential engagement can be achieved between the furnace head cover and the furnace body, which avoids a structural displacement or even a detachment to prevent a seal failure, helping to improve structural stability of the sintering furnace. Further, the flexible connection pipe can deform with a deformation of the furnace body to avoid a structural detachment or damage caused by the deformation of the furnace body, which can otherwise affect material feeding, contributing to improving feeding stability and effectively enhancing operational stability of the sintering furnace. Since the feed inlet is formed at the furnace head cover and the flexible connection pipe is connected to the furnace head cover, a material can enter the furnace body from the furnace head cover at the end of the furnace body, which helps to expand a sintering region within the furnace body while reducing a quantity of holes in the sintering region of the furnace body, contributing to improving a thermal insulation effect of the furnace body.

Further, the sintering furnace according to the above embodiment of the present disclosure can further provide the following additional technical features.

According to some embodiments of the present disclosure, the sliding support structure further includes a first fixing structure having a sliding groove extending in the length direction of the furnace body. The sliding groove has a bottom wall and two side walls, the two side walls being opposite to each other in a horizontal direction perpendicular to the length direction of the furnace body. The first sliding structure is slidably arranged at the bottom wall and located between the two side walls.

According to some embodiments of the present disclosure, a wear-resistant layer is disposed between the first sliding structure and at least one of the bottom wall and the two side walls.

According to some embodiments of the present disclosure, an extension length of the sliding groove in the length direction of the furnace body is d; and a maximum displacement of an edge of the furnace head in the length direction of the furnace body during operation is d0, where d≥d0.

According to some embodiments of the present disclosure, the sliding support structure further includes a first fixing structure. The first sliding structure includes a connection rod, a first connection portion, a second connection portion, and a buffer. The first connection portion is connected to a lower end of the connection rod and slidingly engaged with the first fixing structure. The second connection portion is sleeved on the connection rod and is fixedly connected to the furnace head cover. The buffer is sleeved on the connection rod and has an end abutting against the first connection portion and another end abutting against the second connection portion. The buffer is stretchably deformable in a vertical direction.

According to some embodiments of the present disclosure, an extension length of the flexible connection pipe is L1; in a cold state of the sintering furnace, a straight-line spacing between the feeding device and the feed inlet is L2; and a maximum displacement of the feed inlet in the length direction of the furnace body during operation is L0, where L1−L2>L0.

According to some embodiments of the present disclosure, the furnace body has a spiral groove spirally extending in a circumferential direction of the furnace body. A reserved space is formed between an end wall of the furnace head cover away from the furnace head and an end portion of the furnace head. The feed inlet is formed at a peripheral wall of the reserved space. The furnace head cover is internally provided with a feed pipe including a first pipe segment and a second pipe segment connected to the first pipe segment, the first pipe segment passing through the reserved space and being connected to the feed inlet, the second pipe segment passing through an end opening of the furnace head and extending to a position above the spiral groove, the first pipe segment extending downwards, and the second pipe segment extending obliquely downwards.

According to some embodiments of the present disclosure, a packing box is disposed between an inner circumferential surface of the furnace head cover and an outer circumferential surface of the furnace head, the packing box being provided with a plurality of first packings. A gap space is provided between two adjacent first packings of the plurality of first packings. The packing box has a supply hole for supply of a lubricating medium, the supply hole being in communication with at least one of the gap spaces. The sintering furnace further includes a gland connected to the furnace head cover and stopped at a side of the plurality of first packings away from an end wall of the furnace head cover.

According to some embodiments of the present disclosure, the packing box is further provided with at least one second packing, the at least one second packing being located between the plurality of first packings and the end wall of the furnace head cover, each of the plurality of first packings having a V-shaped axial cross-section, and the second packing having a rectangular axial cross-section.

According to some embodiments of the present disclosure, the furnace body includes a plurality of furnace segments connected in sequence. A support roller structure is provided at at least one of the furnace head of the furnace body, a furnace tail of the furnace body, and a joint between adjacent furnace segments of the plurality of furnace segments. The support roller structure includes a second fixing structure and at least two support rollers rotatably mounted at the second fixing structure, and a rotation axis of each of the at least two support rollers is parallel to the length direction of the furnace body. The at least two support rollers are supported at a lower side of the furnace body and spaced apart from each other in a horizontal direction. The furnace body is movable relative to each of the at least two support rollers in the length direction.

According to some embodiments of the present disclosure, an outer circumferential surface of the furnace body is provided with an annular protrusion extending in a circumferential direction. The sintering furnace further includes a limiting device including two limiting rollers and a driving device. The two limiting rollers are disposed at two axial sides of the annular protrusion, respectively, to limit an axial position of the annular protrusion, and each of the two limiting rollers is adapted to roll against the annular protrusion. The driving device is disposed at a side of the limiting device away from the sliding support structure in the length direction of the furnace body. The driving device is in a transmission connection with the furnace body and configured to drive the furnace body to rotate around the central axis.

According to some embodiments of the present disclosure, a rotation axis of each of the two limiting rollers is away from the annular protrusion in an axial direction of the furnace body and is inclined away from an axis of the furnace body in a radial direction of the furnace body; and in the radial direction of the furnace body, an outer diameter of each of the two limiting rollers gradually increases in a direction away from the axis of the furnace body.

According to some embodiments of the present disclosure, the sintering furnace further includes a furnace tail cover and a tail support device. The furnace tail cover is sleeved on a furnace tail of the furnace body and rotatably engaged with the furnace tail. The furnace tail cover is fixedly supported at the tail support device, or the tail support device includes a third fixing structure and a second sliding structure, the second sliding structure being configured to support and fix the furnace tail cover, and the second sliding structure being mounted at the third fixing structure and slidable relative to the third fixing structure in the length direction of the furnace body.

According to some embodiments of the present disclosure, the flexible connection pipe is made of rubber or polypropylene plastic; and each of a feed channel of the feeding device, the furnace head cover, and the furnace body is made of stainless steel or an alloy.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a front view of a sintering furnace according to an embodiment of the present disclosure.

FIG. 2 is a schematic partial structural view of FIG. 1.

FIG. 3 is a top view of a sintering furnace according to an embodiment of the present disclosure.

FIG. 4 is a schematic partial structural view of FIG. 3.

FIG. 5 is a schematic structural view of a sliding support structure in a sintering furnace according to an embodiment of the present disclosure.

FIG. 6 is a schematic structural view at a flexible connection pipe in a sintering furnace according to an embodiment of the present disclosure.

FIG. 7 is a partial cross-sectional structural view at a packing box in a sintering furnace according to an embodiment of the present disclosure.

FIG. 8 is a schematic structural view at a packing box in a sintering furnace according to an embodiment of the present disclosure.

FIG. 9 is a schematic structural view at a support roller structure in a sintering furnace according to an embodiment of the present disclosure.

FIG. 10 is a schematic structural view at a limiting device in a sintering furnace according to an embodiment of the present disclosure.

FIG. 11 is a bottom view of a partial structure of a sintering furnace according to an embodiment of the present disclosure.

FIG. 12 is an enlarged view at a part indicated by a circle A in FIG. 2.

### REFERENCE NUMERALS OF THE ACCOMPANYING DRAWINGS

sintering furnace 100;
furnace body 10; furnace head 11; furnace segment 12; first furnace segment 121; second furnace segment 122; third furnace segment 123; furnace tail 13; annular protrusion 14; housing 15;
furnace head cover 20; feed inlet 21; feed pipe 22; first pipe segment 223; second pipe segment 224;
sliding support structure 30; first fixing structure 31; sliding groove 311; bottom wall 312; side wall 313;
first sliding structure 32; connection rod 321; first connection portion 322; second connection portion 323; buffer 324; reinforcing rib 33;
feeding device 40; feed outlet 41; flexible connection pipe 50;
packing box 60; second packing 61; first packing 62; supply hole 63; gland 65;
support roller structure 70; second fixing structure 71; support roller 72; support shaft 73; side support 74;
limiting device 80; limiting roller 81; screw rod 82; nut 83; rotation platform 84; driving device 85; motor 86; reducer 87; transmission gear 88; ring gear 89;
furnace tail cover 90; tail support device 91; third fixing structure 96; second sliding structure 97.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

In the description of the present disclosure, it should be understood that, the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation and the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In the description of the present disclosure, “first feature” and “second feature” may include one or more of these features; “plurality” means two or more; the first feature “on” or “under” the second feature may mean that the first feature is in direct contact with the second feature, or the first and second features are in indirect contact through another feature between them; the first feature “above” the second feature means that the first feature is directly above or obliquely above the second feature, or simply means that the level of the first feature is higher than that of the second feature.

A sintering furnace 100 according to the embodiments of the present disclosure is described below with reference to the accompanying drawings.

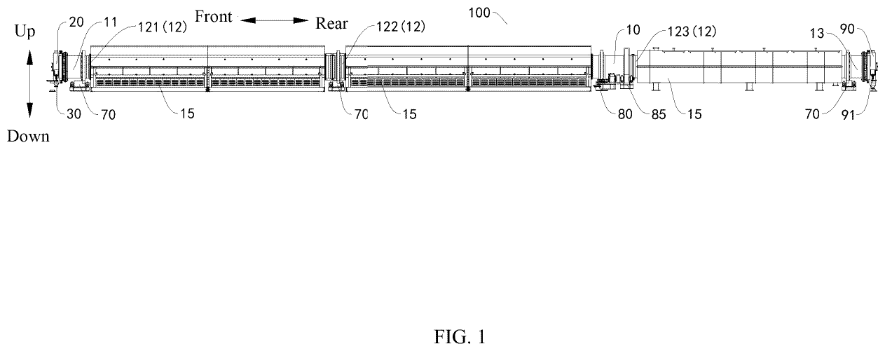

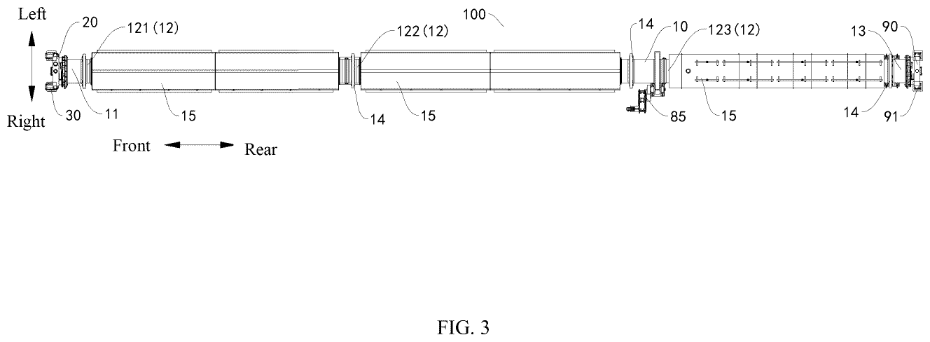

Referring to FIG. 1 to FIG. 12, the sintering furnace 100 according to the embodiments of the present disclosure may include a furnace body 10, a furnace head cover 20, a sliding support structure 30, and a feeding device 40.

Specifically, the furnace head cover 20 has a feed inlet 21 and is sleeved on a furnace head 11 of the furnace body 10. The furnace head cover 20 is axially limited relative to the furnace head 11. The furnace body 10 is rotatable around a central axis relative to the furnace head cover 20. The feed inlet 21 is in communication with an interior of the furnace body 10.

The sliding support structure 30 includes a first sliding structure 32 configured to support the furnace head cover 20. The furnace head cover 20 is fixedly connected to the first sliding structure 32. The first sliding structure 32 is slidably arranged in a length direction (e.g., a front-rear direction as illustrated in FIG. 1 to FIG. 4) of the furnace body 10. The feeding device 40 is in communication with the feed inlet 21 through a flexible connection pipe 50.

The furnace head cover 20 being axially limited relative to the furnace head 11 means that the furnace head cover 20 is configured to be movable in an axial direction of the furnace body 10 in response to expansion or contraction of the furnace body 10 in length. An end of the furnace body 10 is sealed through a structural engagement between the furnace head cover 20 and the furnace head 11 or through a further sealing structure provided between the furnace head cover 20 and the furnace head 11. In addition, since the first sliding structure 32 is fixedly connected to the furnace head cover 20, the first sliding structure 32 fixedly connected to the furnace head cover 20 is slidable in the axial direction when a dimensional deformation occurs in the furnace body 10 due to temperature changes, which allows the furnace head cover 20 to synchronously displace with the furnace head 11 in the axial direction of the furnace body 10, helping to enable the furnace head cover 20 and the furnace body 10 to be supported in a stable manner during the expansion or contraction of the furnace body 10. Therefore, reliability of support for the furnace body 10 can be improved. In addition, a satisfactory axial engagement and a satisfactory circumferential engagement can be achieved between the furnace body 10 and the furnace head cover 20, which avoids a structural displacement or even a detachment to prevent a seal failure that otherwise affects stability of an internal atmosphere of the furnace body 10, helping to improve structural stability of the sintering furnace 100. For example, a relative position between the furnace head cover 20 and the furnace head 11 in the axial direction can be fixed using a rigid structure or a flexible structure to reduce relative movements between the furnace head cover 20 and the furnace head 11 in the axial direction, enabling the furnace head cover 20 and the furnace head 11 to move synchronously in the axial direction. However, due to a structural tolerance, a deformation, or other reasons, a slight relative movement between the furnace head cover 20 and the furnace head 11 in the axial direction may still occur. Such scenarios fall within the protection scope of the present disclosure.

The furnace body 10 is used for sintering a material and the like, and has an integral cylindrical structure, which may be a single cylindrical body or composed of a plurality of cylindrical segments rigidly connected together. The furnace head cover 20 is capable of supporting the furnace head 11 of the furnace body 10. In addition, considering that the feed inlet 21 of the furnace head cover 20 is in communication with the interior of the furnace body 10, the material can be conveyed to the furnace body 10 through the feed inlet 21. The material from the feeding device 40 enters the feed inlet 21 via the flexible connection pipe 50 and then enters the furnace body 10 for sintering. The feeding device 40 may be a weight-reducing hopper or the like. In some embodiments, the feeding device 40 has a feed outlet 41 in communication with the feed inlet 21 through the flexible connection pipe 50. The material from the feeding device 40 enters the flexible connection pipe 50 from the feed outlet 41, and then enters the feed inlet 21.

During the sintering of the sintering furnace 100, a temperature in the furnace body 10 is high, resulting in a relatively large thermal expansion. Therefore, the furnace body 10 is prone to the expansion or contraction deformation, leading to problems such as instability in support. However, with the sliding support structure 30, the furnace head cover 20, the furnace body 10, and the first sliding structure 32 slide together when the furnace body 10 undergoes the expansion or contraction deformation, which helps to adapt to the expansion or contraction deformation of the furnace body 10. In this way, a possibility of shaking or even collapse of the furnace body 10 can be reduced, improving support stability.

In addition, the material is conveyed to the furnace body 10 through the flexible connection pipe 50. The flexible connection pipe 50 is subjected to a deformation (e.g., a stretch deformation, or a bent deformation) in response to the expansion or contraction deformation of the furnace body 10, to adapt to the expansion or contraction deformation of the furnace body 10 that occurs when the furnace body 10 switches between a cold state and a high-temperature state. In this way, during the deformation of the furnace body 10, the flexible connection pipe 50 is less likely to detach from the furnace head cover 20, which results in a relatively stable connection and helps to improve the feeding stability. Further, relatively stable support is provided for the furnace body 10 during the feeding, which helps to further improve the feeding stability. Through an engagement between the sliding support structure 30 and the flexible connection pipe 50, the sintering furnace 100 can adapt to the expansion or contraction deformation of the furnace body 10, which is conducive to improving the support stability and the feeding stability, enhancing the operational stability of the sintering furnace 100. The flexible connection pipe 50 may be made of a deformable material such as polypropylene plastic or rubber.

For example, in some embodiments, the furnace body 10 has an axial dimension greater than 60 m. During the sintering, a maximum temperature of the furnace body 10 reaches up to 800° C., causing a large thermal expansion of the furnace body 10. In this case, an axial dimensional change of the furnace body 10 is up to 40 cm. By configuring the furnace head cover 20 and the first sliding structure 32 to allow the furnace body 10 to slide in the length direction, the furnace head cover 20 and the furnace body 10 can be continuously supported during the deformation of the furnace body 10. In this way, the furnace body 10 is continuously supported by the sliding support structure 30, achieving relatively strong support stability.

The feed inlet 21 is provided at the furnace head cover 20, and the feeding device 40 is in communication with the feed inlet 21 through the flexible connection pipe 50, in such a manner that the material from the feeding device 40 can enter, via the flexible connection pipe 50, the furnace body 10 from the furnace head cover 20 at the end of the furnace body 10, which is conducive to expanding the sintering region within the furnace body 10. Therefore, no holes need to be formed in the furnace body 10 to convey the material into the furnace body 10, which reduces the quantity of holes in the sintering region of the furnace body 10 to reduces a heat loss of the furnace body 10, helping to improve a thermal insulation effect of the furnace body 10. In this way, a high-temperature environment is maintained inside the furnace body 10 for high-temperature sintering of the material. Additionally, reducing the quantity of holes makes the furnace body 10 less prone to cracking, helping to enhance strength of the furnace body 10.

With the sintering furnace 100 according to the embodiment of the present disclosure, the end of the furnace body 10 is sealed through the structural engagement between the furnace head cover 20 and the furnace head 11 or through the further sealing structure provided between the furnace head cover 20 and the furnace head 11. In addition, through the cooperation of the sliding support structure 30, the furnace head cover 20 and the flexible connection pipe 50, the sintering furnace 100 can adapt to the expansion or contraction deformation of the furnace body 10, in such a manner that the furnace head cover 20 and the furnace body 10 are continuously supported in a stable manner during the expansion or contraction deformation. In this way, the satisfactory axial engagement and the satisfactory circumferential engagement can be achieved between the furnace head cover 20 and the furnace body 10, which avoids the structural displacement or even the detachment to prevent the seal failure, helping to improve the structural stability of the sintering furnace 100. Further, the flexible connection pipe 50 can deform with the deformation of the furnace body 10 to avoid a structural detachment or damage caused by the deformation of the furnace body 10, which can otherwise affect material feeding, contributing to improving the feeding stability and effectively enhancing the operational stability of the sintering furnace 100. Since the feed inlet 21 is provided at the furnace head cover 20 and the flexible connection pipe 50 is connected to the furnace head cover 20, a material can enter the furnace body 10 from the furnace head cover 20 at the end of the furnace body 10, which helps to expand the sintering region within the furnace body 10 while reducing the quantity of holes in the sintering region of the furnace body 10, contributing to improving the thermal insulation effect of the furnace body 10.

The first sliding structure 32 can be slidably supported on the ground by mounting wheels at a bottom of the first sliding structure 32 or other means to enable sliding in the length direction of the furnace body 10. Also, the first sliding structure 32 may be supported by other structures to achieve sliding functionality.

For example, in some embodiments of the present disclosure, as illustrated in FIG. 1 to FIG. 5, the sliding support structure 30 further includes a first fixing structure 31 having a sliding groove 311 extending in the length direction of the furnace body 10. The sliding groove 311 has a bottom wall 312 and two side walls 313. The two side walls are opposite to each other in a horizontal direction perpendicular to the length direction of the furnace body. The first sliding structure 32 is slidably arranged at the bottom wall 312 and located between the two side walls 313.

The first sliding structure 32 is mounted at the first fixing structure 31 and slidable relative to the first fixing structure 31 in the length direction of the furnace body 10. The bottom wall 312 is capable of supporting the first sliding structure 32 and restricting a displacement of the first sliding structure 32 in an up-down direction, while the two side walls 313 are capable of restricting a displacement of the first sliding structure 32 in the horizontal direction. In this way, the first sliding structure 32 can only slide in the length direction of the furnace body 10, which reduces a possibility of shaking during sliding of the furnace body 10 through the sliding support structure 30, improving the support reliability.

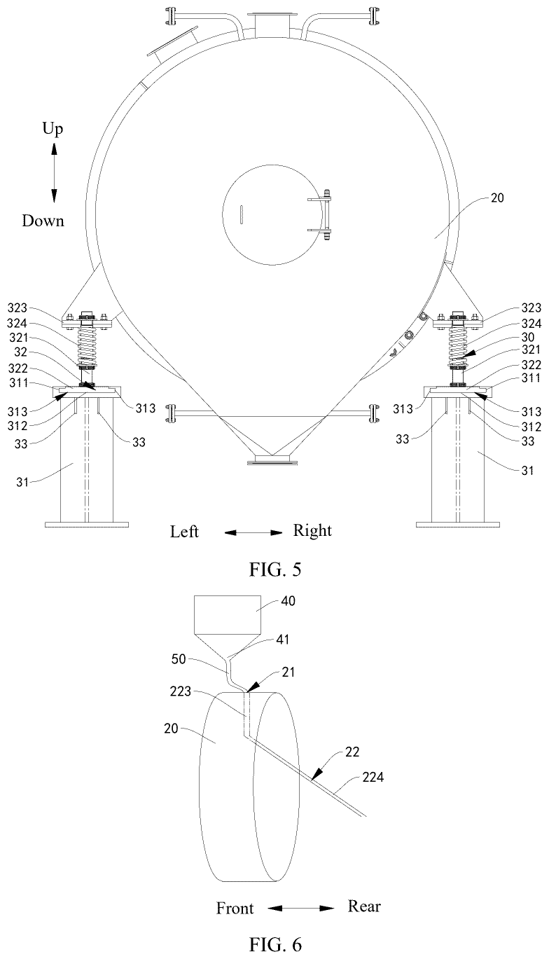

For example, in some specific embodiments, as illustrated in FIG. 5, the position of the first sliding structure 32 is limited by the sliding groove 311 in the up-down direction and a left-right direction, allowing the first sliding structure 32 to slide only in the front-rear direction. When the furnace body 10 undergoes the expansion or contraction deformation in the front-rear direction, the furnace body 10 is slidable in the front-rear direction to adapt to the deformation, providing relatively reliable support.

In some embodiments, the first fixing structure 31 includes an I-beam, which is fixedly mounted at a concrete post by a bolt. A sliding rail defining the sliding groove 311 is welded to an upper end face of the I-beam, which is conducive to enhancing connection reliability between the sliding rail and the I-beam and between the I-beam and the concrete post, improving mounting reliability of the first fixing structure 31.

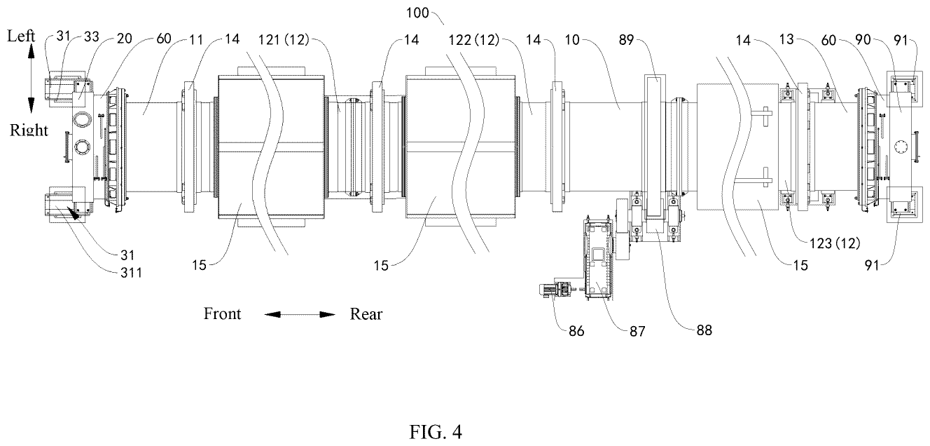

In some embodiments, as illustrated in FIG. 4 and FIG. 5, a reinforcing rib 33 is welded between the sliding rail and the I-beam to enhance mechanical strength of the sliding rail and the I-beam. A quantity and shapes of the reinforcing ribs 33 are not limited in the present disclosure. For example, in some embodiments, four reinforcing ribs 33 are welded in a rectangular arrangement between the sliding rail and the I-beam for ease of processing.

In some embodiments, as illustrated in FIG. 5, a wear-resistant layer is disposed between the first sliding structure 32 and at least one of the bottom wall 312 and the two side walls 313, helping to reduce a sliding resistance of the first sliding structure 32 within the sliding groove 311. In addition, the wear-resistant layer exhibits relatively satisfactory wear resistance, which is conducive to reducing wear and offering relatively satisfactory economic performance.

For example, in some embodiments, the wear-resistant layer may include a ceramic layer, enabling smoother sliding of the first sliding structure 32 within the sliding groove 311 and providing better wear resistance. For example, in other embodiments, the wear-resistant layer is made of stainless steel and has hardness greater than that of each of the bottom wall 312 and the two side walls 313, offering relatively satisfactory wear resistance.

An extension length of the sliding groove 311 in the length direction of the furnace body 10 can be designed based on the length of the furnace body 10. For example, in some embodiments, as illustrated in FIG. 4, the extension length of the sliding groove 311 in the length direction of the furnace body 10 is d, and a maximum displacement of an edge of the furnace head 11 in the length direction of the furnace body 10 during operation is d0, where d≥d0.

During operation of the sintering furnace 100, the maximum displacement of the edge of the furnace head 11 in the length direction of the furnace body 10 is d0. For example, the sintering furnace 100 further includes a limiting device 80 connected to the furnace body 10 and spaced apart from the furnace head 11 in the length direction of the furnace body 10. The limiting device 80 is configured to limit a position of a connected part of the furnace body 10 in the length direction. When the furnace body 10 is in the cold state, a distance between the edge of the furnace head 11 and the limiting device 80 in the length direction of the furnace body 10 is d1. During operation, the furnace body 10 undergoes a thermal expansion due to a temperature rise, causing the edge of the furnace head 11 to displace away from the limiting device 80 in the length direction of the furnace body 10. After an operation condition is stabilized, the distance between the edge of the furnace head 11 and the limiting device 80 in the length direction of the furnace body 10 becomes d2, where d0=d2−d1. A specific value of d0 depends on factors such as the length of the furnace body 10, a position of the limiting device 80 in the length direction of the furnace body 10, a linear expansion coefficient corresponding to a material of the furnace body 10, and a temperature difference between the cold state and an operation state of the furnace body 10, and needs to be determined based on actual heat transfer characteristics of the sintering equipment such as the sintering furnace 100 and a specific sintering process of the material.

To meet a range requirement of the expansion or contraction deformation of the furnace body 10 in the axial direction, the extension length d of the sliding groove 311 in the length direction of the furnace body 10 should be equal to or greater than the maximum displacement d0 of the edge of the furnace head 11 in the length direction of the furnace body 10, i.e., d≥d0. In this way, during operation of the furnace body 10 when the thermal expansion occurs due to the temperature rise, the first sliding structure 32 can be ensured to slide freely within the sliding groove 311 without slipping out of the sliding groove 311, allowing the first sliding structure 32 to provide stable support for the furnace head cover 20 and the furnace head 11.

For example, in some specific embodiments, the furnace body 10 is made of 310S stainless steel. When the furnace body 10 elongates due to the thermal expansion, and the maximum displacement d0 of the edge of the furnace head 11 in the length direction of the furnace body 10 is greater than or equal to 20 cm and smaller than or equal to 80 cm, the extension length d of the sliding groove 311 in the length direction of the furnace body 10 is greater than or equal to d0, which enables the first sliding structure 32 to slide within the sliding groove 311 at all times without slipping out of the sliding groove 311, providing relatively broad applicability. For instance, if d0 is 20 cm, d may be any value greater than or equal to 20 cm, such as 20 cm, 50 cm, or 80 cm. For example, if d0 is 40 cm, d may be any value greater than or equal to 40 cm, such as 40 cm, 60 cm, or 80 cm. In some specific embodiments, d is greater than or equal to 20 cm and smaller than or equal to 80 cm.

In some embodiments of the present disclosure, as illustrated in FIG. 5, the sliding support structure 30 further includes a first fixing structure 31. The first sliding structure 31 includes a connection rod 321, a first connection portion 322, a second connection portion 323, and a buffer 324. The first connection portion 322 is connected to a lower end of the connection rod 321 and slidingly engaged with the first fixing structure 31. The second connection portion 323 is sleeved on the connection rod 321 and is fixedly connected to the furnace head cover 20. The buffer 324 is sleeved on the connection rod 321 and has an end abutting against the first connection portion 322 and another end abutting against the second connection portion 323. The buffer 324 is stretchably deformable in a vertical direction (e.g., in the up-down direction as illustrated in FIG. 5).

When the furnace body 10 undergoes the expansion or contraction deformation, the first connection portion 322 is slidingly engaged with the first fixing structure 31, enabling the furnace head cover 20 and the furnace body 10 to slide to adapt to the deformation of the furnace body 10 in the axial direction. Since the end of the buffer 324 abuts with the first connection portion 322 and the other end abuts with the second connection portion 323, the buffer 324 deforms under a force applied by the second connection portion 323 to cushion the deformation of the furnace body 10 in the vertical direction. In addition, the connection rod 321 is capable of constraining the stretch direction of the buffer 324, which is conducive to meeting a range requirement of the expansion and contraction of the furnace body 10 in the axial direction or the radial direction. The buffer 324 may be a deformable object such as a spring.

In some specific embodiments, as illustrated in FIG. 5, the first connection portion 322 is a slider that is slidably mounted in the sliding groove 311, and the second connection portion 323 is a support plate fixedly connected to the furnace head cover 20. The support plate may be connected to the furnace head cover 20 through welding, riveting, or the like. The support plate is sleeved on the connection rod 321. The support plate and the connection rod 321 may be connected by means such as riveting to prevent a detachment. The buffer 324 is a spring capable of supporting a load of 1 ton, providing better support for the furnace head cover 20.

In some embodiments of the present disclosure, as illustrated in FIG. 6, an extension length of the flexible connection pipe 50 is L1. In the cold state of the sintering furnace 100, a straight-line spacing between the feeding device 40 and the feed inlet 21 is L2. A maximum displacement of the feed inlet 21 in the length direction of the furnace body 10 during operation is L0, where L1−L2>L0.

The extension length of the flexible connection pipe 50 refers to a length of a path extending from an end of the flexible connection pipe 50 to another end of the flexible connection pipe 50 when the flexible connection pipe 50 is undeformed. For example, if the flexible connection pipe 50 extends along an arc, the extension length refers to a length of the arc. Alternatively, if the flexible connection pipe 50 is an elastic and stretchable pipe, the extension length of the flexible connection pipe 50 refers to a maximum length of a path extending from the end of the flexible connection pipe 50 to the other end of the flexible connection pipe 50 within an allowable elastic limit of the flexible connection pipe 50. The straight-line spacing between the feeding device 40 and the feed inlet 21 may refer to a straight-line spacing between the feed outlet 41 and the feed inlet 21.

During operation of the sintering furnace 100, the maximum displacement of the feed inlet 21 in the length direction of the furnace body 10 is L0. For example, the sintering furnace 100 further includes the limiting device 80. When the furnace body 10 is in the cold state, a distance between the feed inlet 21 and the limiting device 80 in the length direction of the furnace body 10 is L3. During operation, the furnace body 10 undergoes the thermal expansion due to the temperature rise, causing the feed inlet 21 to displace away from the limiting device 80 in the length direction of the furnace body 10. After the operation condition is stabilized, the distance between the feed inlet 21 and the limiting device 80 in the length direction of the furnace body 10 becomes L4, where L0=L4−L3. A specific value of LO depends on factors such as the length of the furnace body 10, the position of the limiting device 80 in the length direction of the furnace body 10, a linear expansion coefficient corresponding to the material of the furnace body 10, and the temperature difference between the cold state and the operation state of the furnace body 10, and needs to be determined based on actual heat transfer characteristics of the sintering equipment and the specific sintering process of the material.

When the feed inlet 21 of the furnace head cover 11 moves due to the deformation of the furnace body 10, the flexible connection pipe 50 connecting the feeding device 40 and the feed inlet 21 moves accordingly. Additionally, L1−L2>L0, which ensures that the length of the flexible connection pipe 50 is sufficient to adapt to a maximum movement range of the feed inlet 21. In this way, the flexible connection pipe 50 is less likely to detach from the feed inlet 21 during a movement of the feed inlet 21, improving stability of conveying the material to the furnace body 10 through the flexible connection pipe 50. Moreover, the sufficient length of the flexible connection pipe 50 makes the flexible connection pipe 50 less likely to be affected by external forces, such as tensile forces from the feeding device 40 and the furnace head cover 11, which otherwise affects a material conveying function of the flexible connection pipe 50. Similarly, the feeding device 40 and the furnace head cover 11 are also less likely to be affected by a tensile force from the flexible connection pipe 50 that otherwise affects the operational stability, facilitating smooth sintering. Further, the flexible connection pipe 50 may also be deformable to enable the flexible connection pipe 50 to adapt to a larger movement range of the feed inlet 21, achieving broader applicability.

For example, if L0 is 20 cm, L1−L2 may be any value greater than or equal to 20 cm, such as 21 cm, 25 cm, or 30 cm. For example, if L0 is 80 cm, L1−L2 may be any value greater than or equal to 80 cm, such as 81 cm, 85 cm, or 90 cm.

In some embodiments of the present disclosure, as illustrated in FIG. 6, the furnace body 10 has a spiral groove spirally extending in a circumferential direction of the furnace body 10. A reserved space is provided between an end wall of the furnace head cover 20 away from the furnace head 11 and an end portion of the furnace head 11, and the reserved space is formed by the end wall of the furnace head cover 20 away from the furnace head 11 and the end portion of the furnace head 11. The feed inlet 21 is provided at a peripheral wall of the reserved space. The furnace head cover 20 is internally provided with a feed pipe 22 including a first pipe segment 223 and a second pipe segment 224 connected to the first pipe segment 223. The first pipe segment 223 passes through the reserved space and is connected to the feed inlet 21. The second pipe segment 224 passes through an end opening of the furnace head 11 and extends to a position above the spiral groove. The first pipe segment 223 extends downwards. The second pipe segment 224 extends obliquely downwards.

The spiral groove is capable of guiding the material. For example, in some embodiments, the spiral groove is defined by a helical blade protruding from an inner wall of the furnace body 10. The helical blade extends spirally in the axial direction of the furnace body 10. When the furnace body 10 rotates, the material inside the furnace body 10 is turned over and redistributed under guidance of the helical blade, which pushes the material forwards. In this way, uniformity of distribution of the material is improved, which facilitates the sintering of the material.

The furnace head cover 20 has an end (e.g., a rear end as illustrated in FIG. 6) formed as an opening and connected to the end of the furnace head 11 and another end (e.g., a front end as illustrated in FIG. 6) formed as an end wall forming the reserved space with the end of the furnace head 11. Such a configuration allows the first pipe segment 223 to extend downwards to pass through the reserved space and the second pipe segment 224 to extend obliquely downwards to pass through the end opening of the furnace head 11, which can reduce positional conflicts between the furnace body 10 and the feed pipe 22 during a rotation of the furnace body 10, improving the feeding stability.

The first pipe segment 223 may extend vertically downwards or obliquely downwards. The feed pipe 22 may be disposed in the furnace head cover 20 using methods such as welding. For example, in some embodiments, the feed pipe 22 is welded to the furnace head cover 20 using argon arc welding.

The material flows from the feed inlet 21 of the furnace head cover 20 to the first pipe segment 223 and moves towards the second pipe segment 224 under gravity, without using an external feeding tool, which facilitates guidance of the material to the second pipe segment 224 and subsequent flowing of the material into the spiral groove, ensuring stable conveying of the material.

In some embodiments, as illustrated in FIG. 6, an angle between the second pipe segment 224 and the horizontal direction is greater than an angle of repose of the material, in such a manner that the material in the second pipe segment 224 is likely to flow downwards towards the spiral groove under gravity. Consequently, a possibility of blockages of the material in the feed pipe 22 is reduced, which is beneficial to realize stable feeding of the material. For example, the material is lithium iron phosphate, and the angle between the second pipe segment 224 and the horizontal direction is greater than the angle of repose of lithium iron phosphate.

Additionally, since the sintering of the material such as a positive electrode material for lithium-ion batteries requires a protective gas atmosphere, high requirements are placed on sealing performance of the sintering equipment. Therefore, maintaining gas tightness is also a significant challenge for an application of a large-scale sintering furnace in the sintering such as a high-temperature solid-phase reaction of lithium iron phosphate. In particular, while ensuring reliable sealing, the sealing structure needs to be structurally well adapted to a rotation of a movement part (such as the furnace body) of the sintering furnace during operation, a radial deformation and an axial deformation of the furnace body caused by switching between the cold state and a hot state, a shape error (e.g., ovality or eccentricity) and bending of a geometric centerline of the furnace body during manufacturing, mounting, or transportation.

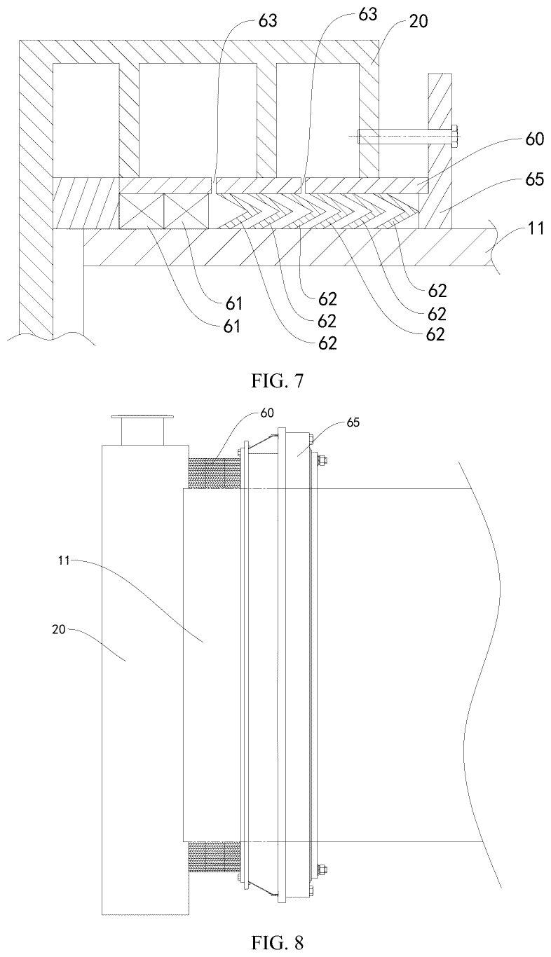

Based on this, the present disclosure provides the following improvements to meet a sealing requirement of the sintering. In some embodiments of the present disclosure, as illustrated in FIG. 1 to FIG. 4, FIG. 7, and FIG. 8, a packing box 60 is disposed between an inner circumferential surface of the furnace head cover 20 and an outer circumferential surface of the furnace head 11. The packing box 60 is provided with a plurality of first packings 62. The first packing 62 is capable of sealing a connection gap between the furnace head cover 20 and the furnace head 11 to improve the sealing performance between the furnace head cover 20 and the furnace head 11, which helps to maintain a protective gas atmosphere such as an inert gas atmosphere inside the sintering furnace 100, preventing an excessive oxygen level from affecting roasting of the material such as lithium iron phosphate. For example, the excessive oxygen level can lead to more lithium iron phosphate oxidizing into byproducts such as ferric salts. In addition, a possibility of the material in the sintering furnace 100 flowing towards an ambient environment or dust or the like from the ambient environment flowing towards the sintering furnace 100 can be reduced to improve the sealing performance between the furnace head cover 20 and the furnace head 11, improving a roasting indicator and a safety and environmental indicator of the sintering furnace 100. The first packing 62 may be made of ceramic fiber, rubber, etc.

In some embodiments, as illustrated in FIG. 7, a gap space is provided between two adjacent first packings 62 of the plurality of first packings 62, and the packing box 60 has a supply hole 63 for supplying a lubricating medium (e.g., grease). The supply hole 63 is in communication with at least one gap space. With the supply hole 63, the lubricating medium can be introduced into the at least one gap space, which helps to reduce corrosion and wear on a contact surface between the furnace body 10 and the packing, reducing a possibility of rust formation on the furnace body 10, and extending a service life of the furnace body 10. For example, in some embodiments, as illustrated in FIG. 7, the gap space and the supply hole 63 at the packing box 60 are opposite to each other in the radial direction and in communication with each other.

In some embodiments, as illustrated in FIG. 7 and FIG. 8, the sintering furnace 100 further includes a gland 65. The gland 65 is connected to the furnace head cover 20 and stopped at a side of the plurality of first packings 62 away from the furnace head cover 20. In this way, fixation of a position of the first packing 62 can be facilitated, enhancing mounting stability and improving sealing effectiveness and sealing longevity of the first packing 62. For example, in some embodiments, as illustrated in FIG. 7, the gland 65 is stopped at a rear side of the first packing 62 and the packing box 60, to fix positions of the first packing 62 and the packing box 60 in the front-rear direction.

In some embodiments, as illustrated in FIG. 7, the packing box 60 is further provided with at least one second packing 61. The at least one second packing 61 is located between the plurality of first packings 62 and the end wall of the furnace head cover 20. Each of the plurality of first packings 62 has a V-shaped axial cross-section. The second packing 61 has a rectangular axial cross-section. The axial cross-section of the packing refers to a cross-section formed by the packing after the packing is intersected by a plane containing an axis of the furnace body 10. The packing can reduce a possibility of the sealing failure during the deformation of the furnace body 10. In addition, cooperation between the first packing 62 and the second packing 61 in different shapes is conducive to improving the sealing performance.

For example, in some embodiments, as illustrated in FIG. 7, two second packings 61 and six first packings 62 are arranged in sequence in the axial direction between the packing box 60 and the furnace head 11. The two second packings 61 form one group, and every three adjacent first packings 62 of the six first packings 62 form another group, creating three groups of packings. Cooling water may be introduced between two adjacent first packings 62 in one group to cool the packings and reduce a possibility of damage to the packings due to an excessive friction temperature. An inert gas such as nitrogen may be introduced between the second packing 61 and the first packing 62 that are adjacent each other. The cooling water and the inert gas are capable of compressing the first packings 62, causing the first packings 62 to expand in the radial direction. In this way, a connection among the furnace head cover 20, the packing, and the furnace head 11 becomes tighter, improving the sealing performance.

The furnace head 11 is rotatable relative to the furnace head cover 20. With the packing box 60, effective sealing can be achieved between a fixed part (i.e., the furnace head cover 20) and a rotatable part (i.e., the furnace head 11) of the sintering furnace 100 to ensure the sealing performance. Additionally, each of the first packing 62 and second packing 61 may be made of rubber or ceramic fiber, which provides each of the first packing 62 and second packing 61 with a predetermined degree of deformation allowance. When the furnace body 10 undergoes the expansion or the deformation in the radial direction due to factors such as a temperature difference during rotation and compresses the packing, the packing can deform in response to the deformation of the furnace body 10 to be in continuous sealing contact with the furnace body 10, which further improves the sealing performance. Moreover, the packing can deform to adapt to the shape error (e.g., ovality or eccentricity) and the bending of the geometric centerline of the furnace body 10 during manufacturing, mounting, or transportation. In addition, when the furnace body 10 undergoes a relatively large dimensional change in the length direction of the furnace body 10, e.g., the thermal expansion, since the furnace head cover 20 is stably supported by the sliding support structure 30, the furnace head cover 20 can slide in the length direction of the furnace body 10 in accordance with the deformation of the furnace body 10. Therefore, during the deformation of the furnace body 10, the furnace head cover 20, the packing box 60, and the furnace head 11 remain tightly connected to ensure the sealing performance, maintaining a stable inert gas atmosphere inside the furnace body 10.

It should be noted that the relative position between the furnace head cover 20 and the furnace head 11 in the axial direction may change due to the deformation of the furnace body 10. However, in the present disclosure, the packing box 60 always ensures a sealed connection between the furnace head cover 20 and the packing box 60, in such a manner that the relative position between the furnace head cover 20 and the furnace head 11 in the axial direction changes relatively little or even remains substantially unchanged, which is conducive to supporting the furnace head cover 20 by the first sliding structure 32 and therefore supporting the furnace body 10, improving the reliability of the support for the furnace body 10.

In some embodiments of the present disclosure, as illustrated in FIG. 1 to FIG. 4 and FIG. 9, the furnace body 10 includes a plurality of furnace segments 12 connected in sequence. A support roller structure 70 is provided at at least one of the furnace head 11 of the furnace body 10, a furnace tail 13 of the furnace body 10, and a joint between adjacent furnace segments 12 of the plurality of furnace segments 12. The support roller structure 70 includes a second fixing structure 71 and at least two support rollers 72 rotatably mounted at the second fixing structure 71, and a rotation axis of each of the at least two support rollers 72 is parallel to the length direction of the furnace body 10. The at least two support rollers 72 are supported at a lower side of the furnace body 10 and spaced apart from each other in a horizontal direction. The furnace body 10 is movable relative to each of the at least two support rollers 72 in the length direction.

The plurality of furnace segments 12 are capable of performing different processing tasks on the material. Since the furnace body 10 is relatively long in the axial direction of the furnace body 10, at least one support roller structure 70 can support the furnace body 10. In addition, the support roller structure 70 cooperates with the sliding support structure 30 at the end to support the entire furnace body 10 and the furnace head cover 20, which is more conducive to enhancing the operational stability of the sintering furnace 100. In some embodiments of the present disclosure, at least four support roller structures 70 are used to support the furnace body 10, providing more stable support for the sintering furnace 100. The support roller 72 is rotatable relative to the second fixing structure 71, and the furnace body 10 is movable relative to the support roller 72 in the length direction, which is conducive to satisfying the rotation of the furnace body 10 and the expansion or contraction deformation of the furnace body 10 in the length direction. By supporting the furnace body 10 with the support roller 72, and with the cooperation of the support roller 72 and the sliding support structure 30, shaking of the furnace body 10 in the radial direction is reduced while adapting to the expansion or contraction deformation of the furnace body 10, which helps to improve sealing reliability between the furnace head 11 and the furnace head cover 20. The support roller 72 may be made of Cr2-series cold-rolled steel or the like.

For example, in some embodiments, as illustrated in FIG. 1 to FIG. 4, the furnace body 10 includes a first furnace segment 121, a second furnace segment 122, and a third furnace segment 123 that are arranged from front to rear. The first furnace segment 121 is used for heating the material. The second furnace segment 122 is used for heat preservation of the material. The third furnace segment 123 is used for cooling the material. Four support roller structures 70 are used to support the furnace head 11, a joint between the first furnace segment 121 and the second furnace segment 122, a joint between the second furnace segment 122 and the third furnace segment 123, and the furnace tail 13, respectively, providing relatively reliable support for the furnace body 10. In addition, the furnace segment 12 is externally provided with a housing 15. The housing 15 is fixed to the concrete post. The furnace segment 12 rotates in the housing 15 around an axis relative to the housing 15, providing relatively high support stability. Further, a length of each of the support rollers 72 of two front support roller structures 70 in the front-rear direction is greater than that of each of the support rollers 72 of two rear support roller structures 70, which is conducive to adapting to a forward expansion or contraction deformation of the heating segment and the heat preservation segment of the furnace body 10 that are at relatively high temperatures. In this way, a risk of the furnace body 10 detaching from the support roller 72 can be reduced, ensuring stable operation.

In some embodiments, an extension length of the support roller 72 in the length direction of the furnace body 10 is greater than or equal to 20 cm and smaller than or equal to 80 cm, allowing the furnace body 10 to slide, on the support roller 72 relative to the second fixing structure 71, freely in the length direction during the deformation, which helps to meet the range requirement of the expansion or contraction deformation of the furnace body 10 in the axial direction. For example, the extension length of the support roller 72 in the length direction of the furnace body 10 may be 20 cm, 60 cm, 80 cm, or the like.

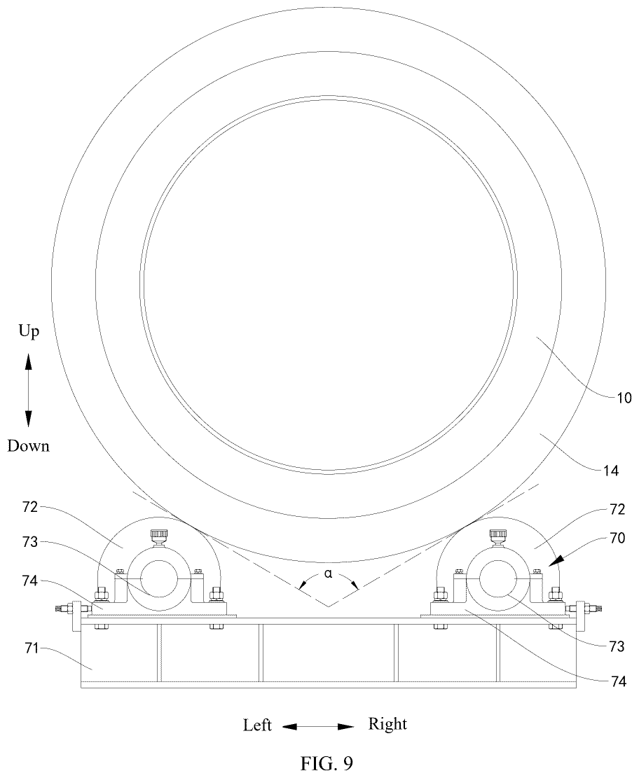

In some specific embodiments, as illustrated in FIG. 9, the support roller structure 70 further includes two support shafts 73 and four side supports 74. The two support shafts 73 are spaced apart in the left-right direction and correspond to the two support rollers 72, respectively. The support roller 72 is sleeved on the support shaft 73. Among the four side supports 74, two side supports 74 are respectively arranged corresponding to a front end and a rear end of the left support shaft 73 in the front-rear direction, and the other two side supports 74 are respectively arranged corresponding to a front end and a rear end of the right support shaft 73 in the front-rear direction. The support shaft 73 is fixedly mounted at the side support 74 by one or more means such as a bolt and a snap. The side support 74 is fixedly mounted at the second fixing structure 71 by one or more means such as a bolt and a snap. The second fixing structure 71 is an I-beam truss made of stainless steel and fixedly mounted at the concrete post by a bolt, which is conducive to enhancing rigidity of the support roller structure 70 and the support stability for the furnace body 10. Further, in one support roller structure 70, extension lines of tangents at contact points between the two support rollers 72 and the furnace body 10 form an angle of 120° (as indicated by α in FIG. 9), providing more stable support for the furnace body 10. In some embodiments, the support roller structure 70 is capable of supporting the furnace body 10 weighing 38 tons.

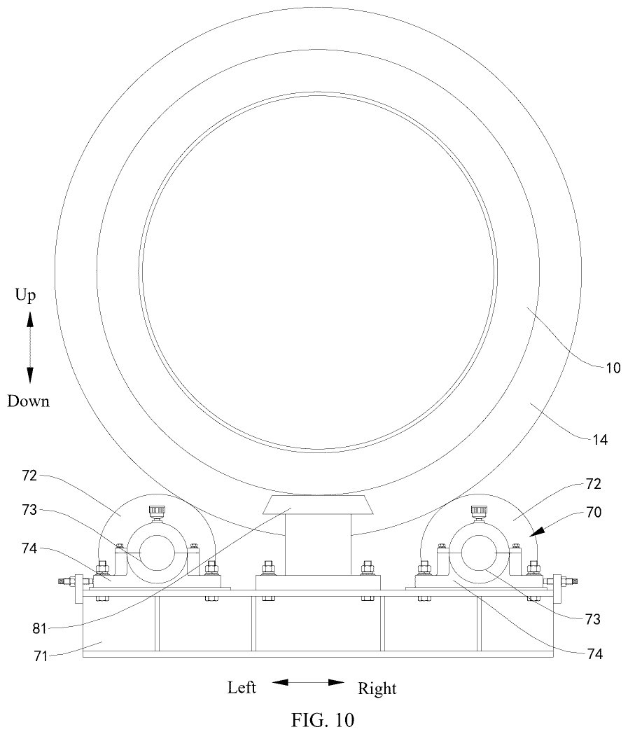

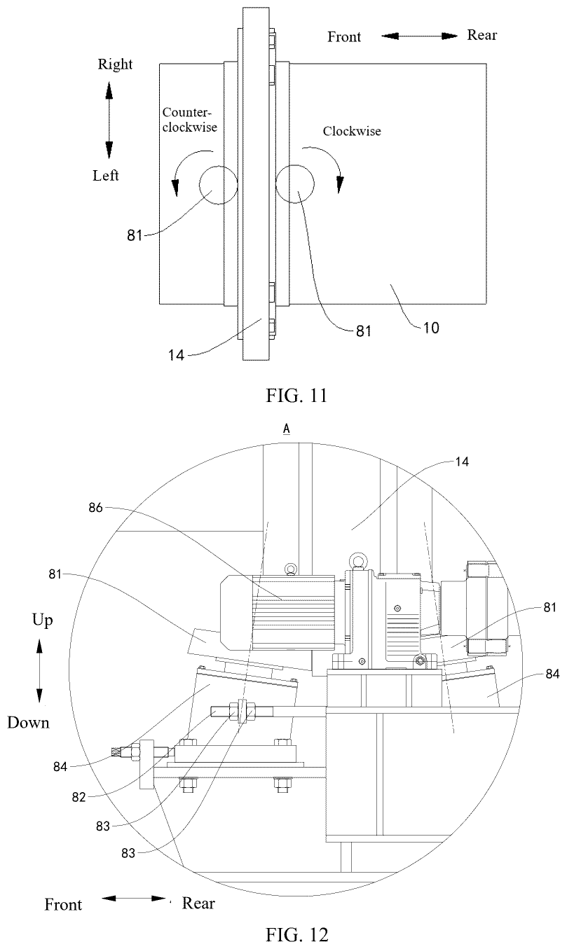

In some embodiments of the present disclosure, as illustrated in FIG. 1 to FIG. 4, FIG. 10, and FIG. 11, an outer circumferential surface of the furnace body 10 is provided with an annular protrusion 14 extending in a circumferential direction, and the sintering furnace 100 further includes a limiting device 80 and a driving device 85.

The limiting device 80 includes two limiting rollers 81. The two limiting rollers 81 are disposed at two axial sides of the annular protrusion 14, respectively, to limit an axial position of the annular protrusion 14. Each of the two limiting rollers 81 is adapted to roll against the annular protrusion 14. The driving device 85 is disposed at a side of the limiting device 80 away from the sliding support structure 30 in the length direction of the furnace body 10. The driving device 85 is in a transmission connection with the furnace body 10 and configured to drive the furnace body 10 to rotate around the central axis.

When the furnace body 10 rotates around the axis of the furnace body 10, the annular protrusion 14 rotates accordingly. Further, the two limiting rollers 81 are configured to clamp the annular protrusion 14 from two axial sides of the annular protrusion 14 and roll against the annular protrusion 14, to limit an axial position of the annular protrusion 14. Consequently, a displacement of the furnace body 10 at the annular protrusion 14 in the axial direction can be restricted to reduce an adverse effect of an axial movement of the furnace body 10 generated when the driving device 85 drives the furnace body 10 to rotate, which is conducive to improving driving stability of the driving device 85 for the furnace body 10. The annular protrusion 14 may be a flange or the like.

For example, in some specific embodiments, as illustrated in FIG. 11, the front limiting roller 81 rotates in a counterclockwise direction as illustrated in FIG. 11, while the rear limiting roller 81 rotates in a clockwise direction as illustrated in FIG. 11. The annular protrusion 14 located between the two limiting rollers 81 rotates around an axis extending in the front-rear direction.

Arranging the driving device 85 at the side of the limiting device 80 away from the sliding support structure 30 helps to reduce the deformation of the furnace body 10 at a position of the driving device 85 and improve the driving stability of the driving device 85. For example, in some embodiments, as illustrated in FIG. 1 to FIG. 4, a position of the annular protrusion 14 in a three-dimensional space is substantially fixed by the limiting device 80. When the furnace body 10 expands and elongates, the furnace body 10 extends forwards with the annular protrusion 14 as an origin, and does not extend backwards under a positional limitation of the limiting device 80. In this way, the driving device 85 can maintain stable transmission cooperation with the furnace body 10 at a rear side of the limiting device 80.

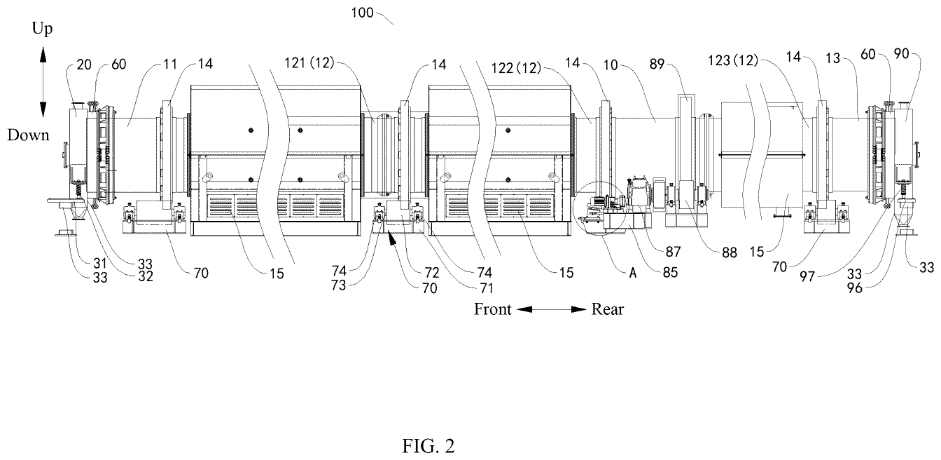

In some embodiments, as illustrated in FIG. 2 and FIG. 4, the furnace body 10 is provided with a ring gear 89 fixedly mounted at the outer circumferential surface of the furnace body 10, and the driving device 85 includes a motor 86, a reducer 87, and a transmission gear 88. The transmission gear 88 is engaged with the ring gear 89. The motor 86 is configured to drive the transmission gear 88 to rotate, which in turn drives the ring gear 89 to rotate, thereby driving the furnace body 10 to rotate. The reducer 87 is configured to increase output torque of the motor 86, providing relatively satisfactory driving performance. With the limiting device 80, the transmission gear 88 can remain in a position engaged with the ring gear 89 without moving, improving the driving stability.

In some embodiments, the support roller structure 70 supports the annular protrusion 14 and therefore supports the furnace body 10. In this way, a localized force acting on the furnace body 10 can be reduced, helping to extend the service life of the furnace body 10.

In some embodiments, as illustrated in FIG. 2, FIG. 10, and FIG. 12, a rotation axis of each of the two limiting rollers 81 is away from the annular protrusion 14 in an axial direction of the furnace body 10 and is inclined away from an axis of the furnace body 10 in a radial direction of the furnace body 10, and in the radial direction of the furnace body 10, an outer diameter of each of the two limiting rollers 81 gradually increases in a direction away from the axis of the furnace body 10. That is, the limiting roller 81 is in a frustum shape and obliquely mounted. Such a design can allow a force exerted by the annular protrusion 14 on the limiting roller 81 to not be perpendicular to an axis of the limiting roller 81 when the limiting roller 81 rolls against the annular protrusion 14, which reduces a magnitude of a force exerted on the limiting roller 81 in a direction perpendicular to the axis of the limiting roller 81. In this way, a risk of damage to the limiting roller 81 is lowered, extending a service life of the limiting roller 81.

For example, in some embodiments, as illustrated in FIG. 2 and FIG. 12, the limiting roller 81 is disposed at a lower side of the furnace body 10, and has a bottom radial outer diameter greater than a top radial outer diameter of the limiting roller 81 to form the frustum shape. The rotation axis of the front limiting roller 81 inclines forwards and downwards, while the rotation axis of the rear limiting roller 81 inclines backwards and downwards.

In some embodiments, as illustrated in FIG. 12, the limiting device 80 further includes two rotation platforms 84, two screw rods 82, and several nuts 83. The two rotation platforms 84 are disposed at two axial sides of the annular protrusion 14, respectively. The two limiting rollers 81 are rotatably disposed at the two rotation platforms 84, respectively. Each of the two rotation platforms 84 is provided with a positioning boss at a same side of the furnace body 10 in the left-right direction. The positioning boss has a through hole. The screw rod 82 passes through the through holes of the positioning bosses of the two rotation platforms 84. The nut 83 is disposed at the screw rod 82 and is located at least at a side of the positioning boss away from the annular protrusion 14. That is, the front nut 83 is disposed at a front side of the front positioning boss, while the rear nut 83 is disposed at a rear side of the rear positioning boss, or each positioning boss is provided with the nut 83 at each of two sides of the positioning boss and tightly compressed by the nuts 83 at the two sides of the positioning boss. The nut 83 is thread-connected to the screw rod 82 to limit the position of the limiting roller 81, which reduces a possibility of the limiting roller 81 to move away from the annular protrusion 14 in the axial direction, improving reliability of the limiting device 80 in limiting the position of the annular protrusion 14.

In some embodiments, as illustrated in FIG. 1 to FIG. 4, the sintering furnace 100 further includes a furnace tail cover 90 and a tail support device 91. The furnace tail cover 90 is sleeved on the furnace tail 13 of the furnace body 10 and is rotatably engaged with the furnace tail 13. The furnace tail cover 90 is capable of supporting the furnace tail 13 to support the furnace body 10.

In some embodiments, the furnace tail cover 90 is fixedly supported at the tail support device 91, which helps to improve mounting stability of the furnace tail cover 90 and the reliability of the support for the furnace body 10.

In some embodiments, as illustrated in FIG. 1 to FIG. 4, the tail support device 91 includes a third fixing structure 96 and a second sliding structure 97. The second sliding structure 97 is configured to support and fix the furnace tail cover 90. In addition, the second sliding structure 97 is mounted at the third fixing structure 96 and slidable relative to the third fixing structure 96 in the length direction of the furnace body 10. When the furnace body 10 undergoes the expansion or contraction deformation, the furnace tail cover 90, the furnace body 10, and the second sliding structure 97 can slide together relative to the third fixing structure 96, which is conducive to adapting to the expansion or contraction deformation of the furnace body 10, improving the support stability.

In the furnace body 10, a temperature near the furnace tail 13 is lower than that near the furnace head 11. That is, the deformation of a part of the furnace body 10 between the furnace tail 13 and the limiting device 80 is smaller than that of a part of the furnace body 10 between the furnace head 11 and the limiting device 80. In some embodiments, a slidable distance of the second sliding structure 97 is smaller than that of the first sliding structure 32, which helps to adapt to the expansion or contraction deformation of the furnace body 10 while saving costs.

In some embodiments, as illustrated in FIG. 2 and FIG. 4, the third fixing structure 96 has a recess extending in the length direction of the furnace body 10, and the second sliding structure 97 is disposed in the recess of the third fixing structure 96. An operation principle of the third fixing structure 96 and the second sliding structure 97 is the same as that of the first fixing structure 31 and the second sliding structure 32 in the sliding support structure 30, and thus details thereof will be omitted here.

In some embodiments, the packing box 60 is disposed between the furnace tail 13 and the furnace tail cover 90, and at least one second packing 61 and a plurality of first packings 62 are disposed between the packing box 60 and the furnace tail 13. In this way, an improvement of sealing performance between the furnace tail 13 and the furnace tail cover 90 is facilitated.

In some embodiments of the present disclosure, the flexible connection pipe 50 is made of a material such as rubber or polypropylene plastic. In this way, a deformation of the flexible connection pipe 50 is facilitated to improve the feeding stability.

In some embodiments, each of a feed channel of the feeding device 40, the furnace head cover 20, and the furnace body 10 is made of an alloy. In this way, strength of the feed channel, the furnace head cover 20, and the furnace body 10 can be enhanced to extend a service life of each of the feed channel, the furnace head cover 20, and the furnace body 10, which facilitates normal operation of the sintering.

In some embodiments, each of the feed channel, the furnace head cover 20, and the furnace body 10 is made of stainless steel. Since stainless steel contains no copper-zinc materials, a possibility of introducing magnetic substances during the high-temperature sintering can be reduced while ensuring the strength of the feed channel, the furnace head cover 20, and the furnace body 10, which is beneficial for magnetic substance control. Some materials have extremely strict requirements for magnetic substance control. For example, lithium iron phosphate requires a magnetic substance level in a final product to be smaller than 0.8 ppm. Consequently, using the feed channel, the furnace head cover 20, and the furnace body 10 made of stainless steel helps to meet the requirements for magnetic substance control of materials.

In some embodiments, each of the feed channel, the furnace body 10, the furnace head cover 20, and the furnace tail cover 90 is made of 310S stainless steel or an Inconel 601/625 alloy, which can withstand a high temperature ranging from 1,000° C. to 1,200° C. In addition, 310S stainless steel or the Inconel 601/625 alloy provides satisfactory rust-resistant and corrosion-resistant properties and relatively satisfactory intergranular corrosion resistance, which is beneficial to effectively reducing a possibility of introducing the magnetic substances during the high-temperature sintering.

Other components and operations of the sintering furnace 100 according to the embodiments of the present disclosure are well known to those skilled in the art, and thus details thereof will be omitted here.

In the description of the present disclosure, it should be noted that, unless otherwise clearly specified and limited, terms such as “install”, “connect”, and “connect to” should be understood in a broad sense. For example, it may be a fixed connection or a detachable connection or connection as one piece; mechanical connection or electrical connection; direct connection or indirect connection through an intermediate; internal communication of two components. For those skilled in the art, the specific meaning of the above-mentioned terms in the present disclosure can be understood according to specific circumstances.

Reference throughout this specification to “an embodiment”, “a specific embodiment”, or “an example” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A sintering furnace, comprising:
a furnace body;
a furnace head cover having a feed inlet, the furnace head cover being sleeved on a furnace head of the furnace body, the furnace head cover being axially limited relative to the furnace head, the furnace body being rotatable around a central axis relative to the furnace head cover, and the feed inlet being in communication with an interior of the furnace body;
a sliding support structure comprising a first sliding structure configured to support the furnace head cover, the furnace head cover being fixedly connected to the first sliding structure, and the first sliding structure being slidably arranged in a length direction of the furnace body; and
a feeding device in communication with the feed inlet through a flexible connection pipe.

2. The sintering furnace according to claim 1, wherein the sliding support structure further comprises:
a first fixing structure having a sliding groove extending in the length direction of the furnace body, the sliding groove having a bottom wall and two side walls, the two side walls being opposite to each other in a horizontal direction perpendicular to the length direction of the furnace body, and the first sliding structure being slidably arranged at the bottom wall and located between the two side walls.

3. The sintering furnace according to claim 2, wherein a wear-resistant layer is disposed between the first sliding structure and at least one of the bottom wall and the two side walls.

4. The sintering furnace according to claim 2, wherein:
an extension length of the sliding groove in the length direction of the furnace body is d; and
a maximum displacement of an edge of the furnace head in the length direction of the furnace body during operation is d0, where d≥d0.

5. The sintering furnace according to claim 1, wherein:
the sliding support structure further comprises a first fixing structure; and
the first sliding structure comprises a connection rod, a first connection portion, a second connection portion, and a buffer, the first connection portion being connected to a lower end of the connection rod and slidingly engaged with the first fixing structure, the second connection portion being sleeved on the connection rod and fixedly connected to the furnace head cover, the buffer being sleeved on the connection rod and stretchably deformable in a vertical direction, and the buffer having an end abutting against the first connection portion and another end abutting against the second connection portion.

6. The sintering furnace according to claim 1, wherein:
an extension length of the flexible connection pipe is L1;
in a cold state of the sintering furnace, a straight-line spacing between the feeding device and the feed inlet is L2; and
a maximum displacement of the feed inlet in the length direction of the furnace body during operation is L0, where L1−L2>L0.

7. The sintering furnace according to claim 1, wherein:
the furnace body has a spiral groove spirally extending in a circumferential direction of the furnace body;
a reserved space is provided between an end wall of the furnace head cover away from the furnace head and an end portion of the furnace head;
the feed inlet is provided at a peripheral wall of the reserved space; and
the furnace head cover is internally provided with a feed pipe comprising a first pipe segment and a second pipe segment connected to the first pipe segment, the first pipe segment passing through the reserved space and being connected to the feed inlet, the second pipe segment passing through an end opening of the furnace head and extending to a position above the spiral groove, the first pipe segment extending downwards, and the second pipe segment extending obliquely downwards.

8. The sintering furnace according to claim 1, wherein:
a packing box is disposed between an inner circumferential surface of the furnace head cover and an outer circumferential surface of the furnace head, the packing box being provided with a plurality of first packings;
a gap space is provided between two adjacent first packings of the plurality of first packings;
the packing box has a supply hole for supply of a lubricating medium, the supply hole being in communication with at least one of the gap spaces; and
the sintering furnace further comprises a gland connected to the furnace head cover and stopped at a side of the plurality of first packings away from an end wall of the furnace head cover.

9. The sintering furnace according to claim 8, wherein the packing box is further provided with at least one second packing located between the plurality of first packings and the end wall of the furnace head cover, each of the plurality of first packings having a V-shaped axial cross-section, and the second packing having a rectangular axial cross-section.

10. The sintering furnace according to claim 1, wherein:
the furnace body comprises a plurality of furnace segments connected in sequence;
a support roller structure is provided at at least one of the furnace head of the furnace body, a furnace tail of the furnace body, and a joint between adjacent furnace segments of the plurality of furnace segments;
the support roller structure comprises a second fixing structure and at least two support rollers rotatably mounted at the second fixing structure, a rotation axis of each of the at least two support rollers being parallel to the length direction of the furnace body, the at least two support rollers being supported at a lower side of the furnace body and spaced apart from each other in a horizontal direction, and the furnace body being movable relative to each of the at least two support rollers in the length direction.

11. The sintering furnace according to claim 1, wherein an outer circumferential surface of the furnace body is provided with an annular protrusion extending in a circumferential direction, and wherein the sintering furnace further comprises:
a limiting device comprising two limiting rollers, the two limiting rollers being disposed at two axial sides of the annular protrusion, respectively, to limit an axial position of the annular protrusion, and each of the two limiting rollers being adapted to roll against the annular protrusion; and
a driving device disposed at a side of the limiting device away from the sliding support structure in the length direction of the furnace body, the driving device being in a transmission connection with the furnace body and configured to drive the furnace body to rotate around the central axis.

12. The sintering furnace according to claim 11, wherein:
a rotation axis of each of the two limiting rollers is away from the annular protrusion in an axial direction of the furnace body and is inclined away from an axis of the furnace body in a radial direction of the furnace body; and
in the radial direction of the furnace body, an outer diameter of each of the two limiting rollers gradually increases in a direction away from the axis of the furnace body.

13. The sintering furnace according to claim 11, further comprising:
a furnace tail cover and a tail support device, the furnace tail cover being sleeved on a furnace tail of the furnace body and rotatably engaged with the furnace tail, wherein:
the furnace tail cover is fixedly supported at the tail support device, or the tail support device comprises a third fixing structure and a second sliding structure, the second sliding structure being configured to support and fix the furnace tail cover, and the second sliding structure being mounted at the third fixing structure and slidable relative to the third fixing structure in the length direction of the furnace body.

14. The sintering furnace according to claim 1, wherein:
the flexible connection pipe is made of rubber or polypropylene plastic; and
each of a feed channel of the feeding device, the furnace head cover, and the furnace body is made of stainless steel or an alloy.
